(19) United States
(12) Patent Application Publication
(10) Pub. No.: US 2026/0144706 A1
(43) Pub. Date: May 28, 2026

(54) MEDICATION STORAGE CASSETTE

(71) Applicant: JVM CO., LTD., Daegu (KR)

(72) Inventors: Sang Wook KIM, Daegu (KR); Jae Ho CHOI, Daegu (KR); Gwang Il HA, Daegu (KR)

(73) Assignee: JVM CO., LTD., Daegu (KR)

(21) Appl. No.: 19/121,757

(22) PCT Filed: Oct. 20, 2023
(86) PCT No.: PCT/KR2023/016308

§ 371 Date: Apr. 16, 2025

(30) Foreign Application Priority Data
Oct. 21, 2022 (KR) 10-2022-0136607

(51) Int. Cl. A61J 1/03; A61J 1/14; A61J 7/00

(52) U.S. Cl. CPC A61J 1/03; A61J 1/1412; A61J 7/0084

(57) ABSTRACT

A medication storage cassette including: a main body portion providing an inner space for storing the medications and mounted on a first cassette mounting portion of the cassette mounting portion disposed in multiple layers. An opening/closing adjusting portion located toward one side of the main body portion to adjust opening and closing of the inner space. The opening/closing adjusting portion may enable the inner space to be open without interfering with a second cassette mounting portion protruding to a front of the main body portion and located at an upper side of the first cassette mounting portion based on a state in which the main body portion is mounted on the first cassette mounting portion. In some instances, the design may enable the medications to be refilled in the state in which the main body portion is mounted on the first cassette mounting portion.

### TECHNICAL FIELD

The present disclosure relates to a medication storage cassette, and more particularly, to a medication storage cassette capable of improving the speed of medication packaging by enabling refilling of medications even in a state in which the medication storage cassette is mounted on a cassette mounting portion of a medication packaging device.

### BACKGROUND ART

Generally, a medication packaging device is a device that automatically dispenses medications from a plurality of medication storage cassettes in which medications are stored according to medication dispensing information such as a so-called prescription and then packages them into medication packaging paper for each single dose.

The medication packaging device finally packages medications into medication packaging paper after going through a series of processes, and the medications packaged in the medication packaging paper are distributed to each patient or ward.

As disclosed in Korean Patent Publication No. 10-2013-0128271, in a conventional medication packaging device, medication storage cassettes are mounted on cassette mounting portions that are a sort of shelves consisting of a plurality of layers, and dispensing of medications is implemented by rotation of division blocks in the medication storage cassettes.

Here, a cover that allows an upper end portion of the medication storage cassette to be open is formed on each medication storage cassette, and medications can be refilled through opening the cover.

In the conventional medication packaging device, for refill of medications, it is necessary to separate the medication storage cassettes from cassette mounting portions located thereabove due to interference with the cassette mounting portions, and thus the operation of the medication packaging device needs to be stopped for the refill of medications.

Stopping the medication packaging device for the refill of medications eventually reduces the speed of medication packaging and becomes a factor that reduces the efficiency of medication packaging, which is the most important element of the medication packaging device.

Due to the above problems, there is an urgent need for research and development of a new-concept medication storage cassette that enables refill of medications even during an operation of a medication packaging device.

### DISCLOSURE

### Technical Problem

The present disclosure is directed to providing a medication storage cassette from which medications are dispensed according to a medication dispensing request (for example, a prescription of a patient) in a state in which the medication storage cassette is mounted on a cassette mounting portion of a medication packaging device, thereby enabling medications to be refilled into the medication storage cassette even while medications are being packaged for each single dose.

### Technical Solution

The present disclosure provides a medication storage cassette mounted on a cassette mounting portion provided in a medication packaging device, which is a device that allows medications to be sorted and discharged for each single dose based on a medication dispensing request, to dispense the medications, the medication storage cassette including: a main body portion providing an inner space for storing the medications and mounted on a first cassette mounting portion of the cassette mounting portion disposed in a plurality of layers; and an opening/closing adjusting portion located toward one side of the main body portion to adjust opening and closing of the inner space, wherein the opening/closing adjusting portion enables the inner space to be open without interfering with a second cassette mounting portion protruding to a front of the main body portion and located at an upper side of the first cassette mounting portion based on a state in which the main body portion is mounted on the first cassette mounting portion, thereby enabling the medications to be refilled in the state in which the main body portion is mounted on the first cassette mounting portion.

The opening/closing adjusting portion of the medication storage cassette according to the present disclosure may have a fixing portion directly and indirectly connected to the main body portion and a lid portion state-changeably connected to the fixing portion to adjust the opening and closing of the inner space, and the lid portion may have a first lid portion rotatably connected to a first portion of the fixing portion provided to protrude to the front of the main body portion, thereby enabling the medications to be refilled in the state in which the main body portion is mounted on the first cassette mounting portion.

The lid portion of the medication storage cassette according to the present disclosure may further have a second lid portion rotatably connected to a second portion of the fixing portion located at a lower side of the second cassette mounting portion, and in a state in which the main body portion is separated from the first cassette mounting portion due to interfering with the second cassette mounting portion, the second lid portion may be rotatable relative to the second portion and may enable the medications to be refilled.

The first portion of the medication storage cassette according to the present disclosure may be provided to protrude upward past the second portion.

The medication storage cassette according to the present disclosure may further include an expansion portion disposed between the main body portion and the opening/closing adjusting portion to expand the size of the inner space.

In a state in which an upper side and a lower side of the expansion portion of the medication storage cassette according to the present disclosure are open, the lower side may be coupled to an upper side of the main body portion, and the upper side may be coupled to the opening/closing adjusting portion.

The medication storage cassette according to the present disclosure may further include: a division block provided in the inner space and rotatable by rotation of a rotating portion of the first cassette mounting portion; a medication blocking unit for, when the medication is dispensed through a space of the division block, blocking another medication from being dispensed; a guide unit for guiding a mounting position of the medication blocking unit; a pressing unit for pressing the guide unit to fix the guide unit to the main body portion; and a fixing unit for fixing the medication blocking unit.

The fixing unit of the medication storage cassette according to the present disclosure may have: a first fixing unit engaged with the medication blocking unit at various positions to adjust the mounting position of the medication blocking unit; and a second fixing unit pressing the medication blocking unit to fix the medication blocking unit in a state in which the medication blocking unit is engaged with the first fixing unit.

The medication storage cassette according to the present disclosure may further include: a rotation preventing unit inserted into a recessed portion formed in a lower side end of the division block to prevent rotation of the division block before the medication storage cassette is mounted on the first cassette mounting portion; and an adjusting unit connected to the rotation preventing unit to implement movement of the position of the rotation preventing unit, wherein, when the medication storage cassette is mounted on the first cassette mounting portion, the adjusting unit may enable the rotation of the division block by allowing the rotation preventing unit to move due to contact with the first cassette mounting portion and detach from the recessed portion.

The medication storage cassette according to the present disclosure may further include an elastic unit allowing the rotation preventing unit to return to its original position and be inserted into the recessed portion again due to a restoration force caused by elasticity when the medication storage cassette is separated from the first cassette mounting portion.

### Advantageous Effects

According to a medication storage cassette according to the present disclosure, since medications are dispensed according to a medication dispensing request (for example, a prescription of a patient) in a state in which the medication storage cassette is mounted on a cassette mounting portion of a medication packaging device, medications can be refilled into the medication storage cassette even while medications are being packaged for each single dose.

In addition, since the size of an inlet for refill of medications can be changed, the speed and convenience of the refill of medications can be improved.

In addition, by allowing a predetermined number of medications to be accurately dispensed each time from the medication storage cassette, accuracy in dispensing of medications can be improved.

In addition, by preventing medications from being abnormally dispensed from the medication storage cassette while medications are being refilled, accuracy in refilling medications can be improved.

Further, by adjusting (expanding) the size of an inner space in which medications may be stored, the amount of medications that may be stored can be effectively adjusted.

### DESCRIPTION OF DRAWINGS

FIG. 1 is a schematic perspective view illustrating a medication packaging device including a medication storage cassette according to one embodiment of the present disclosure.

FIG. 2 is a schematic cross-sectional view along line A-A of FIG. 1 and is a view for describing a state in which the medication storage cassette according to one embodiment of the present disclosure is mounted on a cassette mounting portion provided in the medication packaging device.

FIG. 3 is a schematic perspective view illustrating the medication storage cassette according to one embodiment of the present disclosure.

FIG. 4 is a schematic perspective view illustrating a state in which the medication storage cassette according to one embodiment of the present disclosure is open.

FIG. 5 is a view for describing a situation in which the medication storage cassette according to one embodiment of the present disclosure is refilled with medications in a state in which the medication storage cassette is mounted on the cassette mounting portion.

FIG. 6 is a view for describing a principle in which a predetermined number of medications is accurately dispensed from the medication storage cassette according to one embodiment of the present disclosure.

FIG. 7 is a schematic exploded perspective view for describing a component for accurately dispensing a predetermined number of medications from the medication storage cassette according to one embodiment of the present disclosure.

FIG. 8 is a schematic bottom perspective view illustrating the medication storage cassette according to one embodiment of the present disclosure.

FIGS. 9 and 10 are views for describing operational states of a division block in the medication storage cassette according to one embodiment of the present disclosure.

FIG. 11 is a schematic perspective view illustrating a medication storage cassette according to another embodiment of the present disclosure.

FIG. 12 is a schematic exploded perspective view illustrating the medication storage cassette according to another embodiment of the present disclosure.

### BEST MODE OF THE INVENTION

The present disclosure provides a medication storage cassette mounted on a cassette mounting portion provided in a medication packaging device, which is a device that allows medications to be sorted and discharged for each single dose based on a medication dispensing request, to dispense the medications, the medication storage cassette including: a main body portion providing an inner space for storing the medications and mounted on a first cassette mounting portion of the cassette mounting portion disposed in a plurality of layers; and an opening/closing adjusting portion located toward one side of the main body portion to adjust opening and closing of the inner space, wherein the opening/closing adjusting portion enables the inner space to be open without interfering with a second cassette mounting portion protruding to a front of the main body portion and located at an upper side of the first cassette mounting portion based on a state in which the main body portion is mounted on the first cassette mounting portion, thereby enabling the medications to be refilled in the state in which the main body portion is mounted on the first cassette mounting portion.

### Modes of the Invention

Hereinafter, specific embodiments of the present disclosure will be described in detail with reference to the accompanying drawings. However, the spirit of the present disclosure is not limited by the embodiments presented herein, and those of ordinary skill in the art who understand the spirit of the present disclosure may easily propose other less advanced inventions or other embodiments belonging to the scope of the spirit of the present disclosure by adding another component, changing a component, or omitting a component within the scope of the same spirit, but such inventions or embodiments also pertain to the scope of the spirit of the present disclosure.

In addition, components with the same function within the scope of the same spirit shown in the drawings of different embodiments will be described using the same reference numerals.

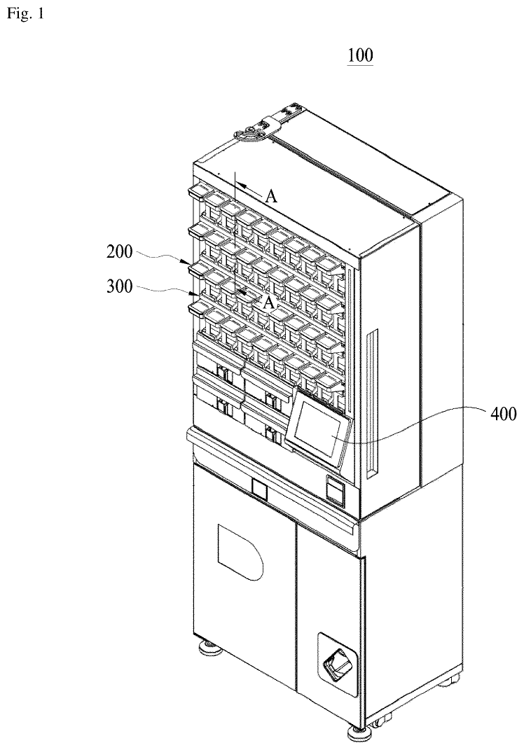

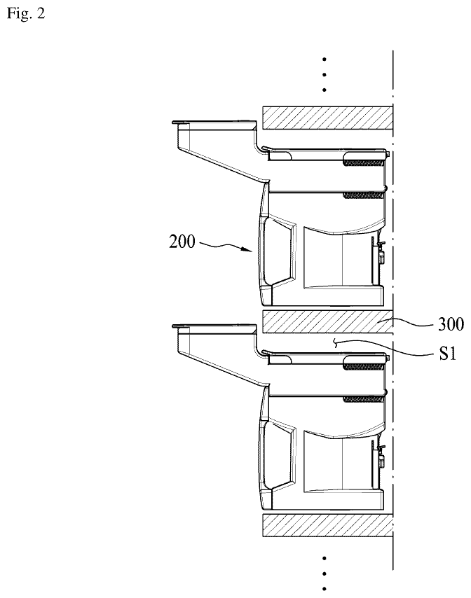

FIG. 1 is a schematic perspective view illustrating a medication packaging device including a medication storage cassette according to one embodiment of the present disclosure, and FIG. 2 is a schematic cross-sectional view along line A-A of FIG. 1 and is a view for describing a state in which the medication storage cassette according to one embodiment of the present disclosure is mounted on a cassette mounting portion provided in the medication packaging device.

Referring to FIGS. 1 and 2, a medication packaging device 100 may be equipment that allows medications dispensed from medication storage cassettes 200 according to the present disclosure, each storing various types of medications separately, based on a medication dispensing request (for example, a prescription of a patient) to be sorted, discharged, and packaged into medication packaging paper for each single dose.

The medication storage cassettes 200 are referred to as canisters or the like in the art, a specific medication may be stored in each medication storage cassette 200, and the medication storage cassettes 200 are mounted on cassette mounting portions 300 to operate.

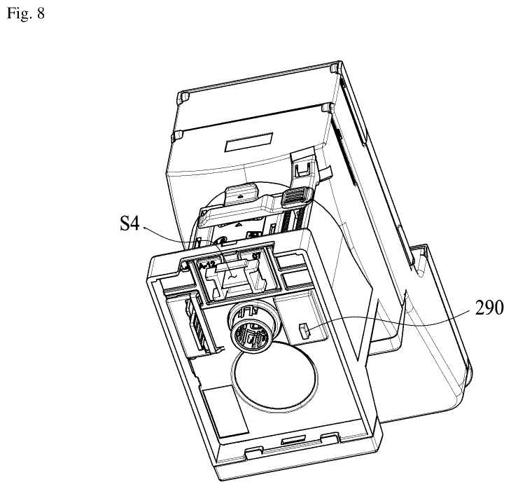

Here, the cassette mounting portions 300 may be a sort of shelves formed of a plurality of layers, and when the medication storage cassette 200 is mounted thereon, as illustrated in FIGS. 8 to 10, a predetermined number of medications may be dispensed from the medication storage cassette 200 by rotating a division block 230.

After the medication storage cassette 200 is mounted on the cassette mounting portion 300, when a medication dispensing request such as a prescription of a patient is received from a server of a hospital or the like by a communication portion (not illustrated) which is one component of the medication packaging device 100, or the medication dispensing request is input through an input portion 400, a rotating portion (not illustrated) of the cassette mounting portion 300 operates due to a controller (not illustrated) which is one component of the medication packaging device 100, and when the rotating portion operates, the division block 230 of the medication storage cassette 200 mounted on the cassette mounting portion 300 and inserted into the rotating portion also rotates and medications are dispensed.

The principle in which medications are dispensed from the medication storage cassette 200 mounted on the cassette mounting portion 300 is disclosed in detail in Korean Patent Publication No. 10-2008-0006339, Korean Patent Publication No. 10-2015-0053331, and Korean Patent Publication No. 10-2005-0117425 previously filed by the present applicant, and thus detailed description thereof will be omitted.

Meanwhile, when the medication storage cassette 200 is mounted on the cassette mounting portion 300, a space S1 between the medication storage cassette 200 and the cassette mounting portion 300 located at an upper side thereof may be very narrow, and thus it may become possible to mount numerous medication storage cassettes 200 in a limited space.

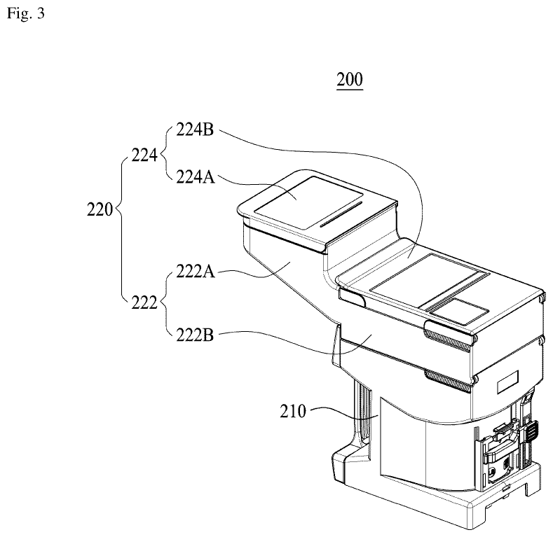

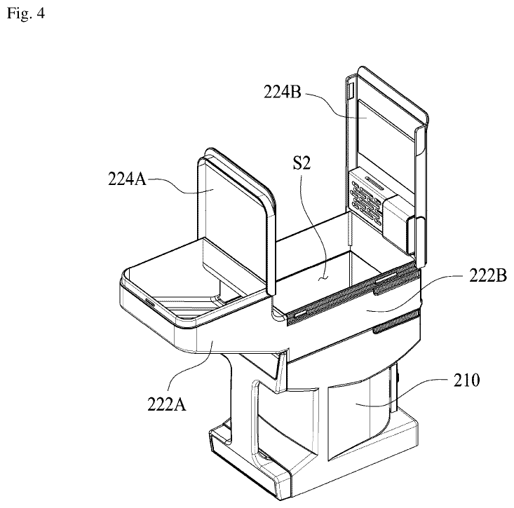

Here, despite the narrow space S1 between the medication storage cassette 200 and the cassette mounting portion 300 located at the upper side thereof, the medication storage cassette 200 according to the present disclosure may be refilled with medications by opening an inner space S2 (see FIG. 4), and this will be described in detail with reference to FIGS. 3 to 5.

FIG. 3 is a schematic perspective view illustrating the medication storage cassette according to one embodiment of the present disclosure, and FIG. 4 is a schematic perspective view illustrating a state in which the medication storage cassette according to one embodiment of the present disclosure is open.

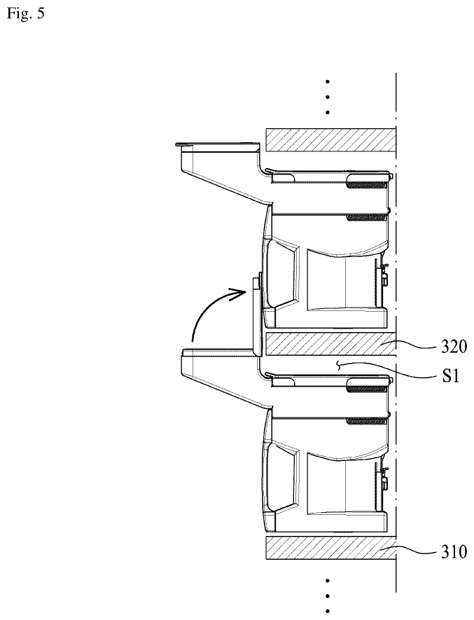

Also, FIG. 5 is a view for describing a situation in which the medication storage cassette according to one embodiment of the present disclosure is refilled with medications in a state in which the medication storage cassette is mounted on the cassette mounting portion.

Referring to FIGS. 3 to 5, the medication storage cassette 200 according to one embodiment of the present disclosure may include a main body portion 210 and an opening/closing adjusting portion 220.

The main body portion 210 may be a component providing the inner space S2 for storing the medications and mounted on a first cassette mounting portion 310 which is one of the cassette mounting portions 300 disposed in a plurality of layers.

The opening/closing adjusting portion 220 may be a type of cover member located toward one side of the main body portion 210 to adjust opening and closing of the inner space S2.

The opening/closing adjusting portion 220 may be connected to the main body portion and enables the inner space S2 to be open without interfering with a second cassette mounting portion 320 protruding to a front of the main body portion 210 and located at an upper side of the first cassette mounting portion 310 based on a state in which the main body portion 210 is mounted on the first cassette mounting portion 310, thereby enabling the medications to be refilled in the state in which the main body portion 210 is mounted on the first cassette mounting portion 310.

The opening/closing adjusting portion 220 may have a fixing portion 222 directly and indirectly connected to the main body portion 210 and a lid portion 224 state-changeably connected to the fixing portion 222 to adjust the opening and closing of the inner space S2.

To enable the inner space S2 to be open without interfering with the second cassette mounting portion 320 located at an upper side of the first cassette mounting portion 310 as described above despite the narrow space S1, the lid portion 224 may have a first lid portion 224A rotatably connected to a first portion 222A of the fixing portion 222 provided to protrude to the front of the main body portion 210, thereby enabling the medications to be refilled in the state in which the main body portion 210 is mounted on the first cassette mounting portion 310.

Meanwhile, the lid portion 224 may further have a second lid portion 224B rotatably connected to a second portion 222B of the fixing portion 222 located at a lower side of the second cassette mounting portion 320.

Due to interference with the second cassette mounting portion 320, the second lid portion 224B may be rotatable relative to the second portion 222B and may enable the medications to be refilled in a state in which the main body portion 210 is separated from the first cassette mounting portion 310.

The first portion 222A of the fixing portion 222 may be formed to protrude upward past the second portion 222B, and thus, a rotating operation of the second lid portion 224B may be more conveniently performed.

In addition, a bottom surface of the first portion 222A of the fixing portion 222 may be formed to be inclined to allow the refilled medications to be naturally introduced into the inner space S2 due to gravity.

Meanwhile, the rotating operations of the first lid portion 224A and the second lid portion 224B may be implemented to be performed automatically by an elastic member such as a spring after an external force is applied, and any known method may apply.

In this way, in the medication storage cassette 200 according to the present disclosure, the size of an inlet for refill of medications can be changed through the first lid portion 224A and the second lid portion 224B, and thus the speed and convenience of the refill of medications can be improved.

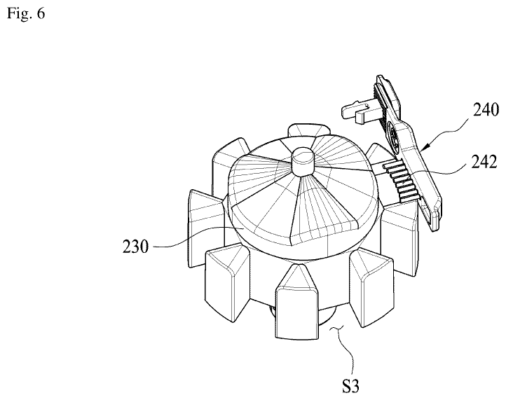

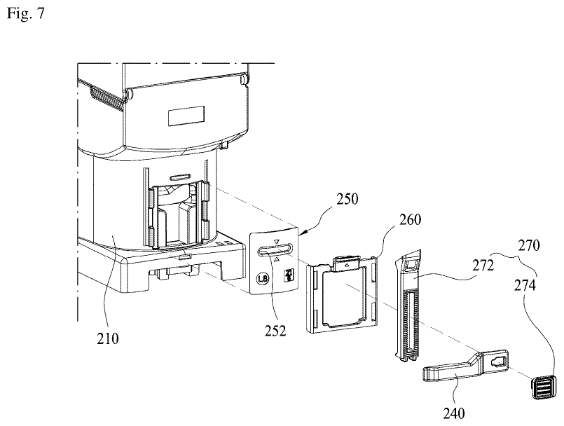

FIG. 6 is a view for describing a principle in which a predetermined number of medications is accurately dispensed from the medication storage cassette according to one embodiment of the present disclosure, and FIG. 7 is a schematic exploded perspective view for describing a component for accurately dispensing a predetermined number of medications from the medication storage cassette according to one embodiment of the present disclosure.

Referring to FIGS. 6 and 7, the medication storage cassette 200 according to one embodiment of the present disclosure may further include the division block 230, a medication blocking unit 240, a guide unit 250, a pressing unit 260, and a fixing unit 270.

The division block 230 is a component provided in the inner space S2 and rotatable by the rotating portion of the first cassette mounting portion 310 and may allow medications to be dispensed through an outlet S4 (see FIG. 8) after being introduced into a space S3 between protruding portions.

The medication blocking unit 240 is a component for, when a predetermined number of medications located in the space S3 of the division block 230 is dispensed through the space S3, blocking medications other than the predetermined number of medications from being dispensed, and the medication blocking unit 240 may cover an upper side of the space S3 present at a position corresponding to the outlet S4 to prevent introduction of medications into the space S3.

The guide unit 250 may be a component for guiding a mounting position of the medication blocking unit 240, and the pressing unit 260 may be a component for fixing the guide unit 250 to the main body portion 210 by pressing the guide unit 250.

A slot 252 for insertion of a blocking portion 242 of the medication blocking unit 240 may be formed in the guide unit 250.

The fixing unit 270 is a component for fixing the medication blocking unit 240 and may have a first fixing unit 272 engaged with the medication blocking unit 240 at various positions to adjust the mounting position of the medication blocking unit 240 and a second fixing unit 274 pressing the medication blocking unit 240 to fix the medication blocking unit 240 in a state in which the medication blocking unit 240 is engaged with the first fixing unit 272.

For the guide unit 250, one that has the slot 252 formed at an optimal position for covering the upper side of the space S3 present at the position corresponding to the outlet S4 that varies according to the shape or the like of the division block 230 may be selected, and the first fixing unit 272 may allow the medication blocking unit 240 to be flexibly fixed at a specific position even when the guide unit 250 changes.

In this way, due to the medication blocking unit 240, a predetermined number of medications can be accurately dispensed each time from the medication storage cassette 200 according to the present disclosure, and thus accuracy in dispensing of medications can be improved.

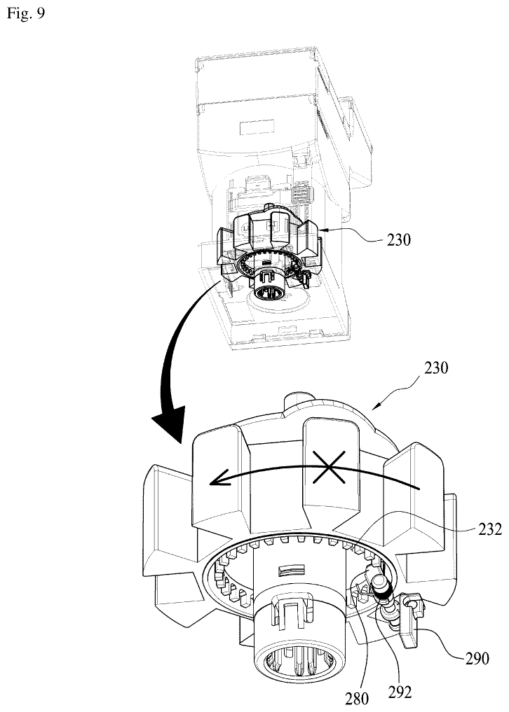

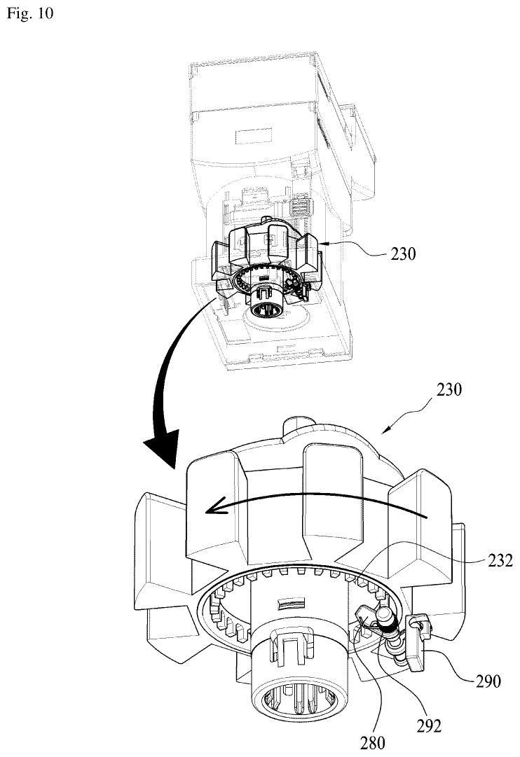

FIG. 8 is a schematic bottom perspective view illustrating the medication storage cassette according to one embodiment of the present disclosure, and FIGS. 9 and 10 are views for describing operational states of a division block in the medication storage cassette according to one embodiment of the present disclosure.

Referring to FIGS. 8 to 10, in a case in which the medication storage cassette 200 according to one embodiment of the present disclosure is separated from the cassette mounting portion 300 and then refilled with medications, in a process of inputting the medications, the input medications should not be dispensed through the space S3 of the division block 230 due to rotation of the division block 230, and to this end, the rotation of the division block 230 should be prevented before the medication storage cassette 200 is mounted on the first cassette mounting portion 310.

The medication storage cassette 200 may include a rotation preventing unit 280 for preventing the rotation of the division block 230 before the medication storage cassette 200 is mounted on the first cassette mounting portion 310, and as illustrated in FIG. 9, the rotation preventing unit 280 may be a component inserted into a recessed portion 232 formed in a lower side end of the division block 230 to prevent the rotation of the division block 230.

In the state illustrated in FIG. 9, when the medication storage cassette 200 is mounted on the cassette mounting portion 300 after being completely filled with medications, as illustrated in FIG. 10, an adjusting unit 290 is pressed, and the adjusting unit 290 moves upward.

The adjusting unit 290 is a component connected to the rotation preventing unit 280 to implement movement of the position of the rotation preventing unit 280, and when the medication storage cassette 200 is mounted on the first cassette mounting portion 310, the adjusting unit 290 may enable the rotation of the division block 230 by allowing the rotation preventing unit 280 to move due to contact with the first cassette mounting portion 310 and detach from the recessed portion 232.

When the adjusting unit 290 moves upward, the rotation preventing unit 280 rotates, and thus the rotation preventing unit 280 inserted into the recessed portion 232 detaches from the recessed portion 232.

Accordingly, it becomes possible for the division block 230 to rotate due to the operation of the rotating portion of the cassette mounting portion 300, and medications can be dispensed from the medication storage cassette 200.

Meanwhile, in a case in which the medication storage cassette 200 mounted on the cassette mounting portion 300 is separated from the cassette mounting portion 300, the adjusting unit 290 returns to a lower side, which is its original position, due to a restoration force caused by elasticity of an elastic unit 292, and thus the rotation preventing unit 280 rotates and is inserted into the recessed portion 232 again.

When the rotation preventing unit 280 is inserted into the recessed portion 232 again, further rotation of the division block 230 is prevented, and nonideal dispensing of medications can be prevented.

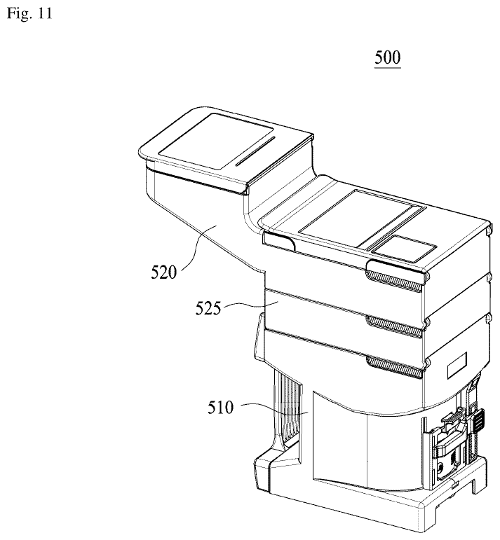

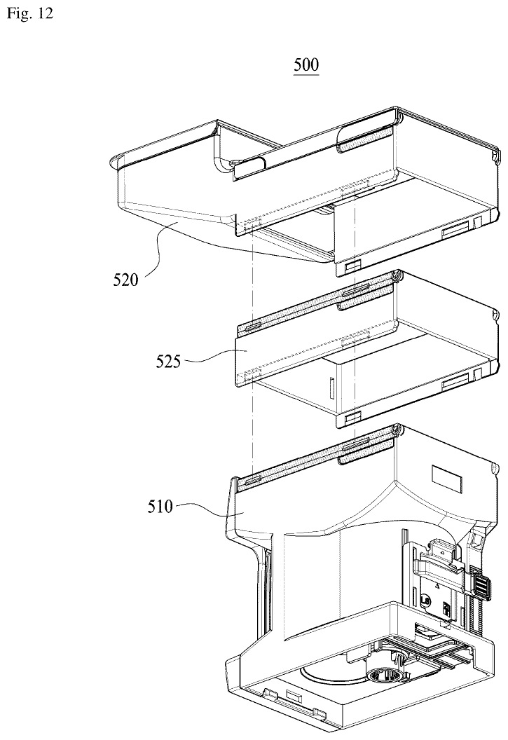

FIG. 11 is a schematic perspective view illustrating a medication storage cassette according to another embodiment of the present disclosure, and FIG. 12 is a schematic exploded perspective view illustrating the medication storage cassette according to another embodiment of the present disclosure.

Referring to FIGS. 11 and 12, as compared to the medication storage cassette 200 according to one embodiment of the present disclosure that has been described above with reference to FIGS. 1 to 10, a medication storage cassette 500 according to another embodiment of the present disclosure has the same configurations and effects except for an expansion portion 525, and thus descriptions of the components other than the expansion portion 525 will be omitted.

The medication storage cassette 500 according to another embodiment of the present disclosure may include a main body portion 510, an opening/closing adjusting portion 520, and the expansion portion 525 for mediating between the main body portion 510 and the opening/closing adjusting portion 520.

The expansion portion 525 may be disposed between the main body portion 510 and the opening/closing adjusting portion 520 to expand the size of an inner space in which medications may be stored.

The expansion portion 525 may be disposed between the main body portion 510 and the opening/closing adjusting portion 520 in a manner in which a plurality of expansion portions 525 are stacked.

The expansion portion 525 may be provided in a state in which an upper side and a lower side thereof are open, the upper side may be coupled to the opening/closing adjusting portion 520, and the lower side may be coupled to an upper side of the main body portion 510.

Configurations and features of the present disclosure have been described above based on embodiments according to the present disclosure, but the present disclosure is not limited thereto. It should be apparent to those of ordinary skill in the art to which the present disclosure pertains that various changes or modifications may be made within the spirit and scope of the present disclosure, and it should be noted that such changes or modifications also fall within the scope of the appended claims.

1. A medication storage cassette mounted on a cassette mounting portion provided in a medication packaging device, which is a device that allows medications to be sorted and discharged for each single dose based on a medication dispensing request, to dispense the medications, the medication storage cassette comprising:
a main body portion providing an inner space for storing the medications and mounted on a first cassette mounting portion of the cassette mounting portion disposed in a plurality of layers; and
an opening/closing adjusting portion located toward one side of the main body portion to adjust opening and closing of the inner space,
wherein the opening/closing adjusting portion enables the inner space to be open without interfering with a second cassette mounting portion protruding to a front of the main body portion and located at an upper side of the first cassette mounting portion based on a state in which the main body portion is mounted on the first cassette mounting portion, thereby enabling the medications to be refilled in the state in which the main body portion is mounted on the first cassette mounting portion.

2. The medication storage cassette of claim 1, wherein:
the opening/closing adjusting portion has a fixing portion directly and indirectly connected to the main body portion and a lid portion state-changeably connected to the fixing portion to adjust the opening and closing of the inner space; and the lid portion has a first lid portion rotatably connected to a first portion of the fixing portion provided to protrude to the front of the main body portion, thereby enabling the medications to be refilled in the state in which the main body portion is mounted on the first cassette mounting portion.

3. The medication storage cassette of claim 2, wherein:
the lid portion further has a second lid portion rotatably connected to a second portion of the fixing portion located at a lower side of the second cassette mounting portion; and
in a state in which the main body portion is separated from the first cassette mounting portion due to interfering with the second cassette mounting portion, the second lid portion is rotatable relative to the second portion and enables the medications to be refilled.

4. The medication storage cassette of claim 3, wherein the first portion is provided to protrude upward past the second portion.

5. The medication storage cassette of claim 1, further comprising an expansion portion disposed between the main body portion and the opening/closing adjusting portion to expand the size of the inner space.

6. The medication storage cassette of claim 5, wherein, in a state in which an upper side and a lower side of the expansion portion are open, the lower side is coupled to an upper side of the main body portion, and the upper side is coupled to the opening/closing adjusting portion.

7.

7. The medication storage cassette of claim 1, further comprising:
a division block provided in the inner space and rotatable by rotation of a rotating portion of the first cassette mounting portion;
a medication blocking unit for, when the medication is dispensed through a space of the division block, blocking another medication from being dispensed;
a guide unit for guiding a mounting position of the medication blocking unit;
a pressing unit for pressing the guide unit to fix the guide unit to the main body portion; and
a fixing unit for fixing the medication blocking unit.

8. The medication storage cassette of claim 7, wherein the fixing unit has a first fixing unit engaged with the medication blocking unit at various positions to adjust the mounting position of the medication blocking unit and a second fixing unit pressing the medication blocking unit to fix the medication blocking unit in a state in which the medication blocking unit is engaged with the first fixing unit.

9. The medication storage cassette of claim 7, further comprising:
a rotation preventing unit inserted into a recessed portion formed in a lower side end of the division block to prevent rotation of the division block before the medication storage cassette is mounted on the first cassette mounting portion; and
an adjusting unit connected to the rotation preventing unit to implement movement of the position of the rotation preventing unit,
wherein, when the medication storage cassette is mounted on the first cassette mounting portion, the adjusting unit enables the rotation of the division block by allowing the rotation preventing unit to move due to contact with the first cassette mounting portion and detach from the recessed portion.

10. The medication storage cassette of claim 9, further comprising an elastic unit allowing the rotation preventing unit to return to its original position and be inserted into the recessed portion again due to a restoration force caused by elasticity when the medication storage cassette is separated from the first cassette mounting portion.
